(19) United States
(12) Patent Application Publication
(10) Pub. No.: US 2008/0247774 A1
(43) Pub. Date: Oct. 9, 2008

(54) IMAGE FORMING APPARATUS

(75) Inventor: Hiroto Koga, Abiko-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 12/056,516

(22) Filed: Mar. 27, 2008

(30) Foreign Application Priority Data
Apr. 3, 2007 (JP) 2007-097887

(51) Int. Cl. G03G 21/20

(52) U.S. Cl. 399/97

(57) ABSTRACT

An image forming apparatus having an image forming section, a sheet storage space, and a dehumidifier device which dehumidifies the sheet storage space includes the dehumidifier device which has a dehumidifier member of a heating regeneration type, a dry space being dehumidified by the dehumidifier member, a regeneration space regenerating the dehumidifier member, a heating section provided in the regeneration space and heating to regenerate the dehumidifier member, a driving section transferring the dehumidifier member in a route between the dry space and the regeneration space, and a partition member dividing the dehumidifier member into a plurality of parts and enabling to partition the dry space and the regeneration space.

### BACKGROUND OF THE INVENTION

1. Field of the Invention

The present invention relates to an image forming apparatus, and particularly to an image forming apparatus wherein a sheet storage space for storing sheets is dehumidified by a dehumidifier.

2. Description of the Related Art

A conventional image forming apparatus such as a copying machine, and a printer is provided with a sheet feeding device which picks up sequentially a sheet by a pickup roller one by one from the uppermost sheet to lower sheets, and then separating sheets by a separating section one by one to feed the sheets to an image forming section. In such a sheet feeding device, a variety of separating manners have been heretofore applied for separating positively sheets one by one.

Incidentally, when an image forming apparatus is left under a highly humid atmosphere, the sheets stored in the image forming apparatus are moistened in the case that they are coat papers the surfaces of which are coated with a coating material, for example, coating compositions.

When sheets are moistened, they are adsorbed with each other so that double sheet feeding or poor sheet feeding arises. Moreover, even if sheet conveyance is possible, it may result easily in a poor image in which transfer properties of a toner image deteriorate, because the insulation resistance of such sheet decreases remarkably.

Under those circumstances, a method has heretofore been proposed for suppressing moisture adsorption, for example, that the ambient surrounding temperature of sheets are raised to prevent the moisture adsorption of the sheets. According to the method, a heater for rising the air temperature inside a sheet feed cassette or a sheet storage space is turned on, whereby the moisture adsorption of sheets is prevented.

However, it is required always to turn on the heater according to the method as mentioned above so that it is wasteful in view of electric power. Thus, a system using a dehumidifier unit containing a chemical absorbent has been proposed. This technology is described in Japanese Patent Application Laid-Open No. 09-44063.

Meanwhile, a device for regenerating a dehumidifier member (desiccant type dehumidifier) which eliminates moisture by using a dehumidifier member being thermally regenerable by heating, and removes the moisture absorbed by heating to dry the dehumidifier member comes to practical use as an indoor dehumidifier system. A raw material such as porous zeolite is used as a thermally regenerable dehumidifier member.

Incidentally, when a dehumidifier heater is used in such a conventional image forming apparatus having a dehumidifier device, the interior of the image forming apparatus is warmed, so that it brings about unnecessary temperature rise in the apparatus. On the other hand, when a thermally regenerable dehumidifier member applied in an indoor dehumidifier device is used, the interior of the image forming apparatus is warmed by the heat for requiring thermal regeneration, so that it brings about unnecessary temperature rise in the apparatus.

In addition, it becomes necessary for complicated control of changing the airflow for switching over from dehumidification to thermal regeneration of a dehumidifier member. In the case that the complicated airflow is not changed, a dry air and a moistened air exist mixedly so that there is such a problem that the efficiency of dehumidification is not increased.

Besides, in such a constitution that the airflow with respect to a dehumidifier member for dehumidification operation is exchanged with the outside, sealing of such apparatus becomes difficult, whereby there is such a problem that the dehumidifier device is inevitably operated continuously so that the electric power consumption increases.

### SUMMARY OF THE INVENTION

The invention has been made in view of the present situation and provides an image forming apparatus which can efficiently perform moisture elimination and regeneration.

According to the present invention, an image forming apparatus has an image forming section, a sheet storage space, and a dehumidifier device which dehumidifies the sheet storage space. The dehumidifier device comprises a dehumidifier member of a heating regeneration type, a dry space dehumidified by the dehumidifier member, a regeneration space regenerating the dehumidifier member, a heating section provided in the regeneration space and heating to regenerate the dehumidifier member, a driving section transferring the dehumidifier member in a route between the dry space and the regeneration space, and a partition member dividing the dehumidifier member into a plurality of parts and enabling to partition the dry space and the regeneration space.

Further features of the present invention will become apparent from the following description of exemplary embodiments (with reference to the attached drawings).

### BRIEF DESCRIPTION OF THE DRAWINGS

FIG. 1 is a sectional view illustrating a printer being one example of the example according to the present invention;

FIG. 2 is a plan view illustrating a sheet feed cassette provided on the printer;

FIG. 3 is a sectional view illustrating the sheet feed cassette;

FIG. 4 is a top view for describing the constitution of a dehumidifier device provided on the printer;

FIG. 5 is a flowchart for illustrating dehumidification control operations of the dehumidifier device provided on the printer by means of a controller;

FIG. 6 is a diagram illustrating the constitution of the controller;

FIG. 7 is a plan view illustrating a cassette for feeding special sheets to be fitted to an image forming apparatus according to a second example of the present invention;

FIG. 8 is a plan view illustrating a cassette to which the cassette for feeding the special sheets is fitted;

FIG. 9 is a sectional view illustrating the cassette to which the cassette for feeding the special sheets is fitted; and

FIGS. 10A and 10B are perspective views each illustrating the cassette for special sheets.

### DESCRIPTION OF THE EMBODIMENTS

In the following, an exemplary embodiment for embodying the present invention will be described in detail by referring to the accompanying drawings.

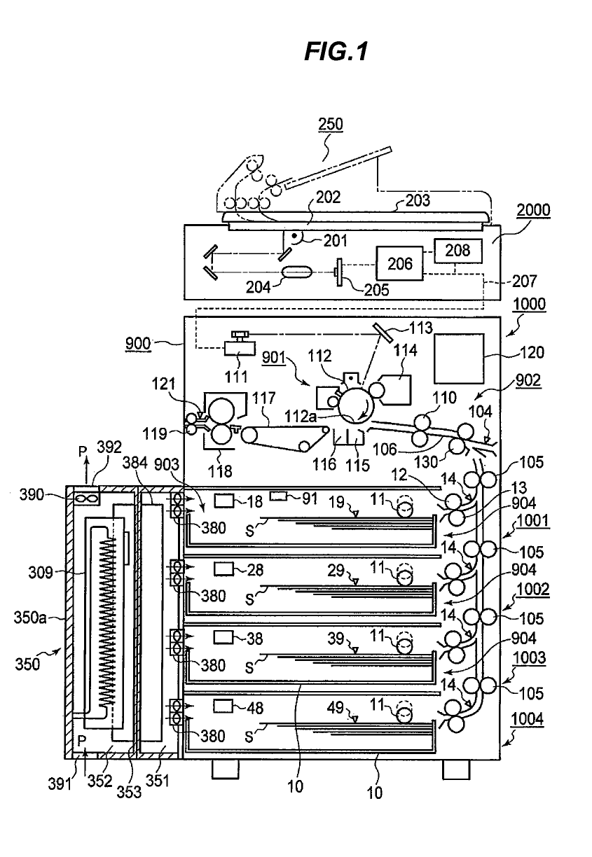

FIG. 1 is a sectional view illustrating an example of the printer according to the example of the present invention.

In FIG. 1, a printer 1000 has a printer main body 900 involving an image forming section 901, and a scanner 2000 placed on the top of the printer main body 900 and for reading an original.

The scanner 2000 has a scanning optical system light source 201, a platen glass 202, an opening and closing original pressure plate 203, a lens 204, a photodetector (photoelectric conversion) 205, an image processing portion 206, and a memory section 208 for storing the image processing signal processed in the image processing portion 206.

In case of reading an original, light is illuminated on the original (not shown) transferred onto the platen glass 202 by means of an original automatically feeding device 250 from the scanning optical system light source 201, whereby the original is read. The original image read is processed by the image processing portion 206, thereafter it is converted into electrical signals 207 which are encoded electrically, and they are transmitted to a laser scanner 111 being an image forming means. Otherwise it may be arranged in such that the image information processed and encoded in the image processing portion 206 is once stored in the memory section 208, and the image information stored once is transferred to the laser scanner 111 in response to signals from a controller 120 which will be mentioned hereunder according to need.

The printer main body 900 has sheet feeding devices 1001 to 1004, and a sheet conveying apparatus 902 for conveying a sheet S fed from any of the sheet feeding apparatuses 1001 to 1004 to the image forming section 901. Furthermore, the printer main body 900 has the controller 120 being a control means for controlling the printer 1000.

Each of the sheet feeding devices 1001 to 1004 has a separation section including a sheet feed cassette 10 being a sheet storage section for storing sheets, a pickup roller 11, a feed roller 12, and retard roller 13. It is arranged in such that the sheet S in the cassette 10 is separated and fed one by one by the action of the pickup roller 11 which lifts/rotates in a predetermined timing and the separation section. Moreover, a sheet feed sensor 14 is disposed in the vicinities of the downstream side in the sheet conveying direction of the feed roller 12 and the retard roller 13, and it is constituted in such that the transit of the sheet S can be detected by the sheet feed sensor 14.

The sheet conveying apparatus 902 has a pair of convey rollers 105, and a resist roller section having a pair of preresist rollers 130 and a pair of resist rollers 110. The sheet S fed from any of the sheet feeding devices 1001 to 1004 is adapted to pass through a sheet convey passage constituted by a guide plate by means of the pair of convey rollers 105, and then to be guided to the pair of resist rollers 110. Moreover, the sheet S is adapted to be conveyed to the image forming section 901 by the pair of resist rollers 110.

The image forming section 901 has a photosensitive drum 112, a laser scanner 111, a development device 114, a transfer charger 115, and a separating charger 116. In case of image formation, the laser beam from the laser scanner 111 is tuned back by a mirror 113 to illuminate on the photosensitive drum 112 rotating in clockwise direction, whereby a latent image is formed on the photosensitive drum 112. Furthermore, the latent image thus formed on the photosensitive drum 112 is then adapted to be visualized as a toner image by means of the development device 114.

The toner image on the photosensitive drum 112 is then transferred to the sheet S by the transfer charger 115 in a transfer section 112a. Moreover, the sheet S on which the toner image is thus transferred is electrostatically separated by the separating charger 116 from the photosensitive drum 112, then transferred to a fixing device 118 by a conveyor belt 117 wherein the toner image is fixed, and thereafter the resulting sheet S is discharged by a discharge roller 119.

In addition, a sheet discharge sensor 121 is disposed in a convey route between the fixing device 118 and the discharge roller 119, and it is constituted in such that the transit of the sheet S discharged can be detected by the sheet discharge sensor 121.

In FIG. 1, a cassette storage case 903 is positioned in the lower part of the printer main body 900 and constituting a sheet storage space wherein a plurality (four) of cassette storage sections 904 each of which is in a substantially sealed condition except for a discharge port are disposed in the vertical direction. Respective sheet feed cassettes 10 are contained in the cassette storage sections 904.

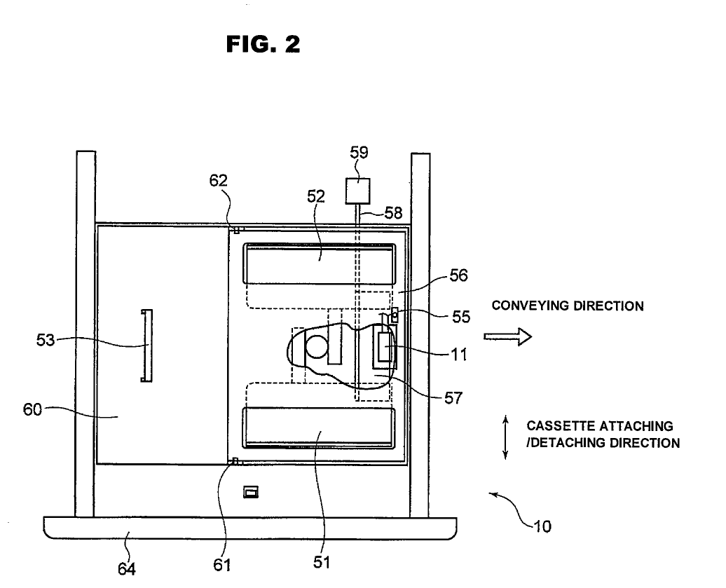

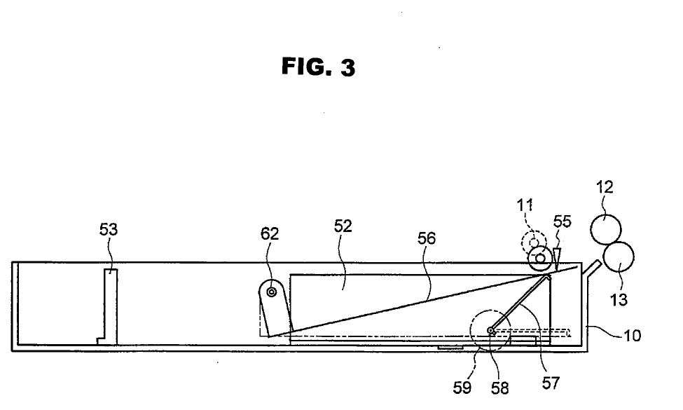

FIG. 2 is a plan view illustrating the constitution of the sheet feed cassette 10, and FIG. 3 is a principal sectional view of FIG. 2. In the present example, the sheet feed cassette 10 is attached and detached from the width direction of the cassette storage section 904 perpendicular to the convey direction of a sheet with respect thereto.

In FIGS. 2 and 3, sheet side restriction plates 51 and 52 for restricting the position of sheets loaded and stored in the sheet feed cassette 10 in the width direction thereof. The sheet side restriction plates 51 and 52 are shiftable so as to allow a distance between the sheet side restriction plates 51 and 52 to coincide with the size of sheets. A restriction plate for the rear end of sheets 53 (referred optionally to as “sheet rear end restriction plate”) is disposed to restrict the rear end position of sheets in the conveying direction thereof; and the sheet rear end restriction plate 53 is shiftable in the sheet convey direction to restrict the position of the rear end of the sheets so as to coincide with the size of sheets.

The sheet feed cassette 10 can be drawn along cassette rail (not shown) provided on the inner wall surface of the cassette storage section 904. Consequently, the sheet feed cassette 10 can be drawn towards the front side of the printer main body 900 in the case that sheets are set by a user.

When the sheet feed cassette 10 is stored in the cassette storage section 904, the storage thereof is detected by cassette attachment/detachment sensors 18, 28, 38, and 48 being loading detection section for detecting the presence of the sheet feed cassette 10 shown in FIG. 1.

The detection signals from the cassette attachment/detachment sensors 18, 28, 38, and 48 are transmitted to a controller 120. The controller 120 can detect whether or not a condition is in that the sheet feed cassette 10 is attached to the cassette storage section 904 based on the detection signals from the cassette attachment/detachment sensors 18, 28, 38, and 48.

Inside the sheet feed cassette 10, a sheet loading plate 56 for loading sheets S and being rotatable around shafts 61 and 62 as the points of support in the vertical direction of the sheet feed cassette 10 is provided; and a lifter plate 57 being a lifting member for lifting the sheet loading plate 56 is disposed under the sheet loading plate 56. The lifter plate 57 is attached to a lifter drive shaft 58; and the lifter plate 57 is rotatable by means of driving input from a lifter drive gear 59 provided on the lifter drive shaft 58.

When the sheet feed cassette 10 is attached to the printer main body 900, a drive instruction is transmitted to the lifter drive gear 59 from a drive source (not shown) to rotate upwardly the lifter plate 57, and consequently, the sheet loading plate 56 is rotated upwardly. Thus, the sheets loaded on the sheet loading plate 56 are in pressure contact with the pickup roller 11; and when the pickup roller 11 is rotated while retaining this condition, a sheet is shipped off.

Over the sheet feed cassette 10, a sheet surface position detection sensor 55 for detecting whether or not the position of the sheet surface of the uppermost sheet loaded on the sheet loading plate 56 is in a suitable height for feeding, namely detecting that the position of the sheet surface of the uppermost sheet reaches the position at which the sheet may be fed is disposed.

The controller 120 rotates the lifter plate 57 based on the signal from the sheet surface position detection sensor 55, whereby it is arranged in such that the sheet surface position of the uppermost sheet is retained in a suitable sheet surface height. With the sheet feeding operation, sheets are fed sequentially from the upper position so that the sheet surface height decreases gradually. As a consequence, when the sheet surface position detection sensor 55 is turned OFF, the controller 120 is caused to rotate again upwardly the lifter plate 57 to rotate upwardly the sheet loading plate 56 by means of a driving source (not shown). Thus, the sheet surface position of the uppermost sheet can be controlled in a constant range.

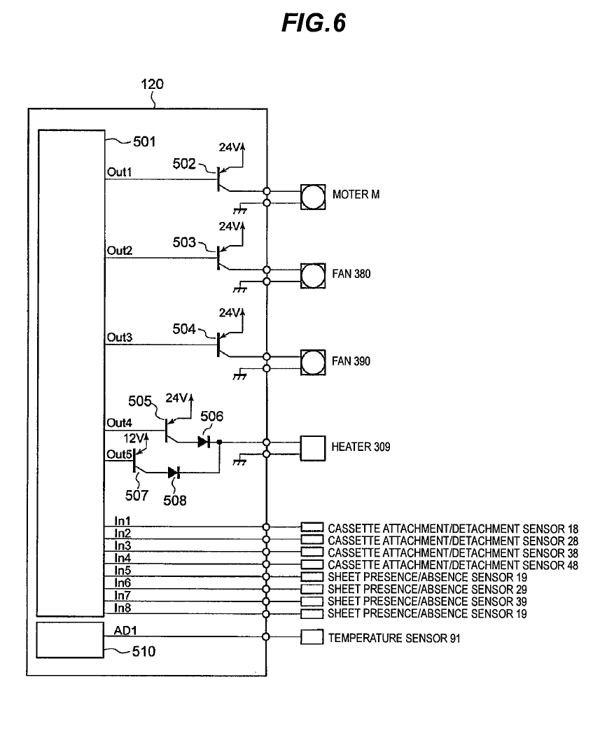

In FIG. 1, there are provided sheet presence/absence detection sensors 19, 29, 39, and 49 being sheet presence/absence detecting sections which detect the presence or absence of sheets in the respective cassettes, and a humidity sensor 91 is a humidity detecting section for detecting the humidity in the sheet storage case 903 (the cassette storage section 904). The detection signals of these respective sensors are input to the controller 120 as shown in FIG. 6 which will be mentioned later.

In FIG. 1, there are further provided a dehumidifier device 350 disposed adjacent to the cassette storage case 903, and a casing 350a for the dehumidifier device 350. Inside the casing 350a, a dehumidifier duct 351 constituting a drying space communicating with the cassette storage case 903, and a heating regeneration duct 352 for regenerating a dehumidifier member which will be mentioned hereunder are formed.

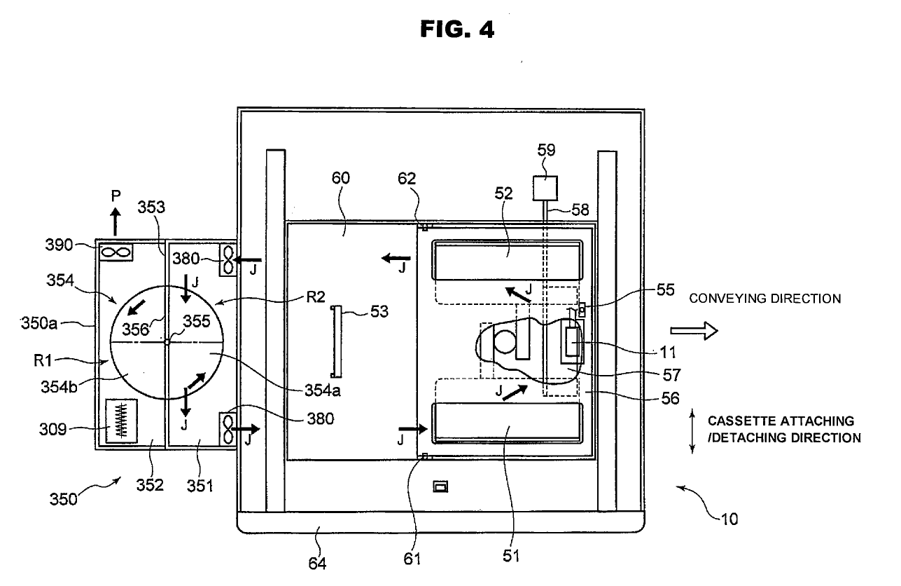

Inside the heating regeneration duct 352, a heating heater 309 being a heating section is further disposed; and the heating regeneration duct 352 has an outside air guide intake 391 and an exhaust port 392. In addition, an exhaust passage R1 provided with an exhaust fan 390 is provided inside the heating regeneration duct 352. An exhaust airflow P for exhausting the air containing moisture is formed by the exhaust passage R1. In the dehumidifier duct 351, an internal circulation airflow J (shown in FIG. 4) is formed with the cassette storage section 904 by means of an internal circulation fan 380 provided on a communication section with the cassette storage section 904.

In the central part of the dehumidifier device 350, the dehumidifier member 354 of a cylinder-shaped heating regeneration type is rotatably suspended. When a rotating shaft 355 disposed vertically at the cylinder center is rotated by a motor M being a rotation driving section shown in FIG. 6 which will be mentioned hereinafter, the dehumidifier member 354 can be rotated in every 180 degrees in clockwise direction (the arrow in FIG. 4).

The cylindrical-shaped dehumidifier member 354 is divided into a plurality of sections, for example, two sections by means of a plate-like partition member 356 in the rotating (moving) direction. In the present example, the dehumidifier member 354 is formed by fixing crescentic dehumidifier materials in section of heating regeneration type onto the opposite surfaces of the partition member 356, respectively.

In FIGS. 1 and 4, a stationary wall 353 is disposed inside the casing to partition the dehumidifier duct 351 and the heating regeneration duct 352. The dehumidifier member 354 is attached in such a manner that the position of the partition member 356 coincides with that of the stationary wall 353 in response to the rotation position as shown in FIG. 4. When the position of the partition member 356 coincides with that of the stationary wall 353, the dehumidifier duct 351 can be partitioned from the heating regeneration duct 352.

When the partition member 356 is in a position wherein the dehumidifier duct 351 is partitioned from the heating regeneration duct 352, a half of the dehumidifier member 354 is positioned in the dehumidifier duct 351, while the other half of the dehumidifier member 354 is positioned in the heating regeneration duct 352.

Consequently, dehumidification is conducted in a part 354a on the side of the dehumidifier duct of the dehumidifier member 354 (hereinafter referred to as “dehumidifier duct side part” 354a) in the dehumidifier duct 351. On one hand, heating regeneration treatment is conducted with respect to a part 354b on the side of the heating regeneration of the dehumidifier member 354 (hereinafter referred to as “heating regeneration duct side part” 354b) in the heating regeneration duct 352. Hence, when a half each of the dehumidifier member 354 is positioned in the dehumidifier duct 351 and the heating regeneration duct 352, respectively, dehumidification and heating regeneration can be efficiently implemented.

Contact portions defined between the opposite ends of the partition member 356 and the stationary wall 353 may be constituted by a sealing member made of an elastic material such as rubber in order to seal hermetically the ducts. The dehumidifier member 354 of heating regeneration type is constituted by a raw material such as zeolite including a porous material which absorbs moisture under an air environment containing moisture, while which releases the moisture under an environment at high temperatures.

In the following, dehumidifying and heating regeneration operations in the dehumidifier device 350 constituted as described above will be described.

Inside the cassette storage case 903 which is substantially closed hermetically, an airflow J indicated by the arrow is usually produced by a fan 380 as shown in FIG. 4, and the moisture in the cassette storage case is absorbed in the dehumidifier duct side part 354a, whereby the interior of the cassette storage case is dehumidified.

Thereafter, the dehumidifier member 354 is rotated by 180 degrees with centering on the rotating shaft 355 at a predetermined timing. As a result, the dehumidifier duct side part 354a which has absorbed moisture is transferred to the side of the heating regeneration duct, and at the same time, the heating regeneration duct side part 354b which has positioned on the heating regeneration duct 352 until then is transferred inside the dehumidifier duct 351.

In this condition, the heating regeneration duct side part 354b is heated by the heating heater 309 to be dried. Consequently, the heating regeneration duct side part 354b can absorb the moisture in the cassette storage case thereafter. On the other hand, the dehumidifier duct side part 354a transferred to the side of the heating regeneration duct is heated by the heating heater 309 to be dried and regenerated in the heating regeneration duct 352.

As a result of the heating and drying operations, the moisture discharged from the dehumidifier duct side part 354a is exhausted outside the apparatus main body through the exhaust port 392 by means of the airflow P produced by the fan 390.

Thereafter, the dehumidifier duct side part 354a regenerated so as to enable to conduct dehumidification as a result of releasing the moisture absorbed is transferred again to the side of the dehumidifier duct by means of rotation drive. According to the cycle as mentioned above, dehumidification of the cassette storage case 903 can be made. Consequently, sheets stored in the sheet feed cassettes 10 attached to four cassette storage sections 904 disposed in the cassette storage case 903 can be dehumidified.

In case of such dehumidifying operations, since the interior of the cassette storage case is dehumidified in the condition wherein there is substantially closed hermetically, so that the efficiency of dehumidification is high. Moreover, since the invention is constituted as described above, a complicated control for switching an airflow is not required; and the air containing heat of heating regeneration can be discharged outside the dehumidifier device without passing through the inside of the dehumidifier device or the cassette storage case 903. As a consequence, unnecessary temperature rise of the interior of the dehumidifier device or the cassette storage case 903 can be prevented.

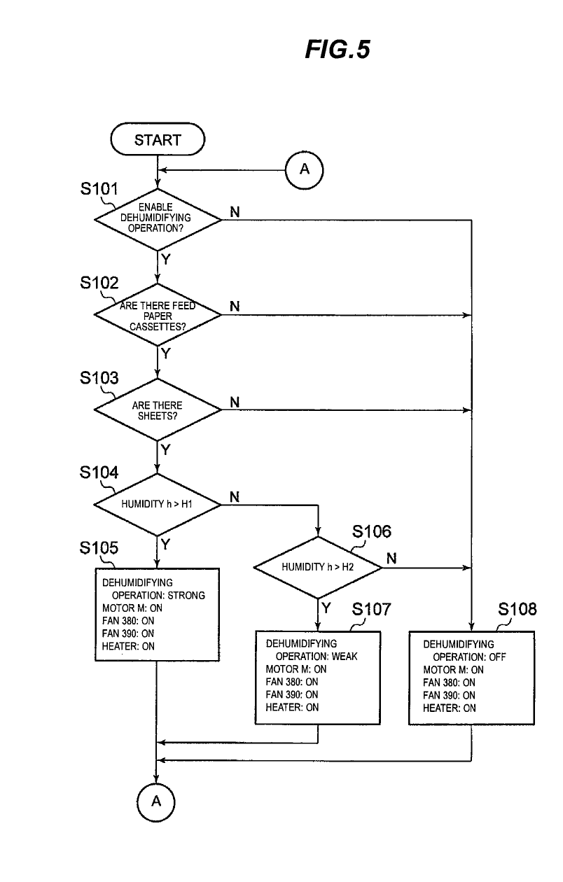

Next, a specific example of dehumidification controlling operations of the dehumidifier device 350 by means of the controller 120 will be described by referring to the flowchart illustrated in FIG. 5 and FIG. 6 illustrating the constitution of the controller 120.

For instance, either when a dehumidifying operation is instructed by a user through an operating section (not shown), or when time instant reaches a predetermined dehumidification timing, the controller 120 judges first whether or not the dehumidifying operation is possible from the viewpoint of electric power in case of implementing the dehumidifying operation (S101). Namely, the operation mode is judged. Because there is required to limit an electric power in case of a low electric power mode of the printer 1000, or in case of an operation mode, for example, in a printing operation, and consequently the dehumidifying operation cannot be conducted.

When it is judged that the dehumidifying operation is possible (Yes in S101), then the controller 120 judges whether or not the sheet feed cassettes 10 are stored in the cassette storage section 904 (S102). In this case, when the inputs In1 to In4 from the cassette attachment/detachment sensors 18, 28, 38, and 48 indicate the presence of all the sheet feed cassettes, it is judged that there are the sheet feed cassettes (Yes in S102), and then it is judged whether or not there are sheets in the sheet feed cassettes 10 (S103).

In this case, when any of the inputs In5 to In8 from the sheet presence/absence detection sensors 19, 29, 39, and 49 indicate the presence of sheets, the controller 120 judges that there are sheets (Yes in S103). Then, the controller 120 judges whether or not the humidity h in the cassette storage case is in H1 being a predetermined value or a higher value by the detection signal of the humidity sensor 91 (S104).

In this case, the controller 120 judges that the interior of the cassette storage case (cassette storage section) is in high humid condition in the case that the humidity value h detected based on the A/D value from the humidity sensor 91 is the predetermined H1 or higher (Yes in S104), so that a strong dehumidifying operation is applied (S105). In this case, it is arranged that the Out1 to Out3 shown in FIG. 6 are to be level L, the motor M, the fan 380, and the fan 390 are turned on, further the Out4 is to be level L and the Out5 is to be level H, and the heating heater 309 is driven at 24 volts, whereby a heating operation is strongly conducted.

Thus, the cassette storage case 903 is dehumidified by the dehumidifier duct side part 354a. Thereafter, when the dehumidifier member 354 is rotated by 180 degrees, the dehumidifier duct side part 354a is transferred to the heating regeneration duct 352, it is subjected to heating regeneration treatment in the heating regeneration duct by means of the heating heater 309, and the dehumidifier duct side part 354a is in a standby condition for the following dehumidifying operation.

In the case that the humidity h is H1 or less (No in S104), then, the controller 120 judges whether or not the humidity h is H2 or more (S106). At that time, the controller 120 judges that the interior of the cassette storage case is in a moderately humid condition in the case that the humidity value h detected based on the A/D value from the humidity sensor 91 is a predetermined humidity H2 or higher (Yes in S106), so that a weak dehumidifying operation is conducted (S107).

In this case, it is arranged that the Out1 to Out3 are to be level L, the motor M, the fan 380, and the fan 390 are turned on, further the Out4 is to be level H and the Out5 is to be level L, and the heating heater 309 is driven at 12 volts, whereby a weak heating operation is conducted.

The controller 120 stops the dehumidifying operation (S108) in the case that the humidity h is H2 or less (No in S106), or that the dehumidifying operation is not conducted in accordance with the conditions of the steps S101 to S103. In this case, it is arranged that the Out1 to Out5 are to be level H, the motor M, the fan 380, the fan 390, and the heating heater 309 are turned off.

The control of the dehumidifying operations in response to the conditions in the cassette storage case wherein the dehumidifier member 354 of heating regeneration type is used can be made by means of the sequence and the control circuit which enables realizing the sequence as described above.

As mentioned above, the dehumidifier device 350 can implement a dehumidifying operation in the dehumidifier duct side part 354a, and further can implement a regenerating operation in the heating regeneration duct side part 354b. Thus, the dehumidifier member 354 which has been regenerated always can be supplied to the dehumidifier duct 351.

Namely, since the cycle of moisture absorption→heating regeneration→moisture absorption is carried out in the dehumidifier member 354, the cassette storage case 903 can be retained always in a low humid condition. Consequently, the interior of the cassette storage case can be maintained in a low humid condition even under a high humid environment, whereby the adsorption between coated papers can be prevented. Furthermore, moisture absorption in sheets can be suppressed also in case of image formation, so that a transfer electric current can be kept constant, whereby a good toner image can be transferred.

Namely, the dehumidifier member 354 which partitions the dehumidifier duct 351 from the heating regeneration duct 352 is rotated to transfer the dehumidifier duct side part 354a to the dehumidifier duct 351, and the dehumidifier duct side part 354a thus transferred is heated to regenerate by means of the heating heater 309, whereby dehumidification and regeneration can be efficiently implemented. As a result, malfunctions in sheet feeding and the appearance of poor image can be suppressed, and in addition, it can contribute to decrease the electricity consumption of the apparatus.

Although the above-described control operations according to the invention has been made based on the presence/absence of the sheet feed cassettes 10, the presence/absence of sheets, and the humidity in the cassette storage case 903, the information to be input is not limited to that mentioned above, but any information may be applied in the present invention so far as the information is that which detects the condition in the site where is a target to be dehumidified.

Furthermore, although the invention has been described in respect of the changes in the voltages to be applied to the heater 309 in the case that strong and weak dehumidifying operations are to be changed, the same effects may be obtained by combining the control of airflow amount made by the voltages to be applied to the fans 380 and 390 with the manner as described above.

Although the invention has been described in the case that the heater 309 is driven by a DC voltage, and the voltage to be applied to the heater 309 is changed by changing the application of a DC voltage, the invention is not limited thereto. But, for example, the same effect can be realized by the duty control in accordance with PWM driving, or the control of the number in turn-on plural heaters 309 in case of driving by means of a DC voltage. Besides, the same effects can be obtained also by changing full-wave driving/half-wave driving, or changing wave number control.

In the present example, although such constitution that the dehumidifier device 350 is provided in communication with the cassette storage case 903, whereby dehumidification is conducted has been described, the dehumidifier device may be communicated with any single or plural stages each among the plural (four) cassette storage sections 904. Furthermore, the constitution of the present invention is not limited to the cassette storage case 903, but such constitution that the dehumidifier device 350 is attached to the printer main body 900, and the dehumidification in the printer main body is checked may also be applied.

In the following, a second example of the present invention will be described. In the present example, a dehumidifier device 350 is attached to a sheet feed cassette.

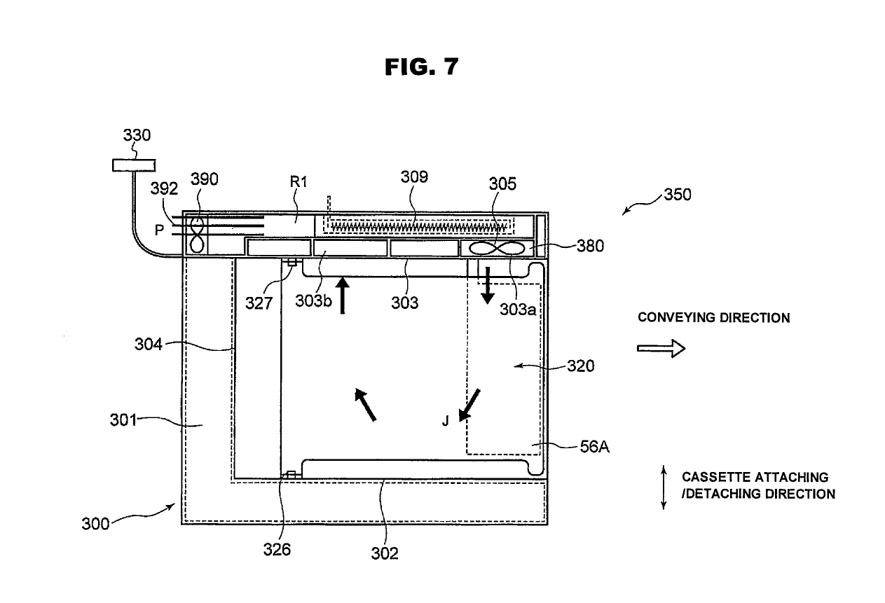

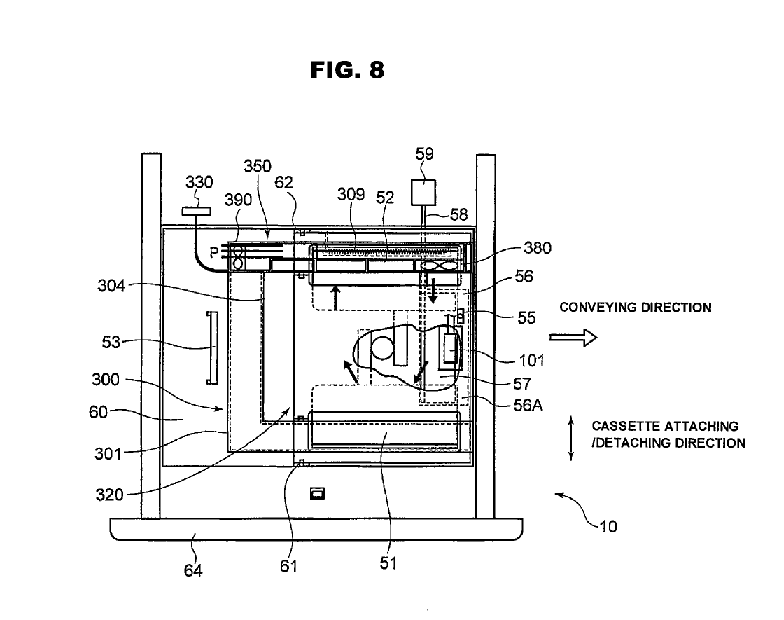

FIG. 7 is a plan view illustrating a sheet feed cassette 300 for special sheets (hereinafter referred optionally to as “special sheet feed cassette”) being an expanded-use cassette and to which a dehumidifier device is attached; the sheet feed cassette being to be attached to the image forming apparatus according to the present example. The special sheet feed cassette 300 is applied to a cassette 10 for expanded-use as shown in FIG. 8 in the case that hardly separated sheets such as coated papers are stored. In the present example, although the special sheet feed cassette 300 is applied to a cassette 10 for expanded-use, it may be constituted in such that the special sheet feed cassette 300 is directly fitted detachably to the cassette storage case 903 as a sheet feed cassette.

As illustrated in FIGS. 7 and 8, the special sheet feed cassette 300 has a casing 301. In the casing 301, sheet storage sections 320 coinciding with the dimensions of A4 size, B4 size etc. which are constituted by inner walls 302 and 303 in the width direction, and an inner wall 304 in the rear end in the sheet feeding direction are provided. A sheet loading plate 56A is held in the sheet storage section 320 in a vertically rotatable (movable) manner by means of support sections 326 and 327.

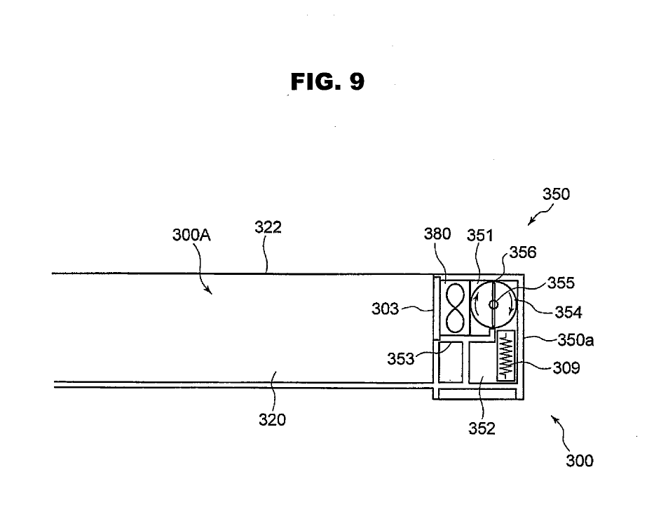

The dehumidifier device 350 is attached to the special sheet feed cassette 300 through an inner wall 303 on the depth side in the width direction. The dehumidifier device 350 has a casing 350a within which a dehumidifier duct 351 communicated with the sheet storage space which is mentioned later and a heating regeneration duct 352 for regenerating the dehumidifier member 354 are firmed as illustrated in FIG. 9.

Inside the heating regeneration duct 352, a heating heater 309 is disposed, and further there are an outside air guide port (not shown) and an exhaust port 392 as well as an exhaust passage R1 provided with an exhaust fan 390. An exhaust airflow P for discharging the air containing moisture to the outside is formed by the exhaust passage R1. Furthermore, an internal circulation airflow J is formed between the dehumidifier duct 351 and the sheet storage space which is mentioned later by an internal circulation fan 380 disposed in a section communicated with the sheet storage space in the dehumidifier duct 351.

Moreover, the columnar dehumidifier member 354 of heating regeneration type is provided rotatably on the dehumidifier device 350 along the inner wall 303 on the depth side. The dehumidifier member 354 may be rotated by a rotating shaft 355 disposed at the center of the cylinder in every 180 degrees in clockwise direction (the arrow). The dehumidifier member 354 is attached in such that when it is rotated by 180 degrees, the position thereof coincides with that of a stationary wall 353. When the position of a partition member 356 coincides with that of the stationary wall 353, the dehumidifier duct 351 can be partitioned from the heating regeneration duct 352.

When the dehumidifier member 354 is in a position at which the dehumidifier duct 351 is partitioned from the heating regeneration duct 352, a half of the dehumidifier member 354 is positioned in the dehumidifier duct 351 and the other half in the heating regeneration duct 352, respectively. Thus, dehumidification is conducted in a dehumidifier duct side part 354a in the dehumidifier duct 351, and heating regeneration treatment is implemented with respect to a heating regeneration duct side part 354b.

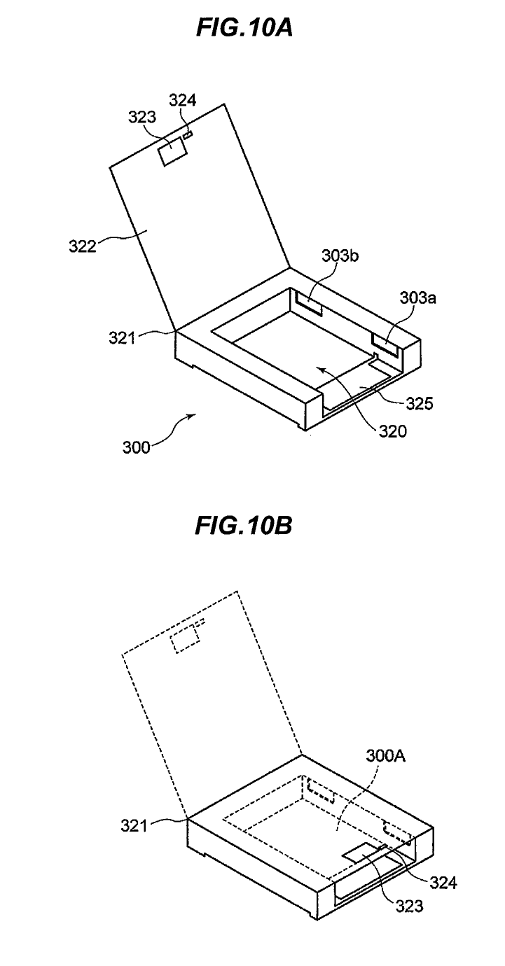

As illustrated in FIGS. 10A and 10B, over a sheet storage section 320, a cover 322 which hermetically-closes substantially the sheet storage section 320 to form a sheet storage space 300A is disposed by the use of a hinge 321 in an openable and closeable manner.

The cover 322 is adapted to position at the position where is in upper position than that of the uppermost sheet of the sheets (not shown) stored in the sheet storage section 320 by a predetermined amount in the closed condition shown in FIG. 10B so as not to be a load in case of transferring sheets. Moreover, there are provided an escape hatch 323 for a sensor of sheet surface position (see FIG. 3) and an escape hatch 324 for a pickup roller (see FIG. 3).

Moreover, the cover 322 has a simple locking means such as MAGIC TAPE (registered trademark), and a sealing member such as Moltpren (trade name) (not shown) so as to be closely in contact with the casing 301 in case of closing the cover 322 for avoiding such troubles that the cover 322 floats up due to air blasting, and that isolating effect of sheets is prevented due to air leakage. In the present example, a clearance between the cover 322 and the uppermost sheet in case of closing the cover 322 is arranged to be, for example, around 2 to 20 mm, whereby the transfer of sheets and the separation of sheets may be smoothly conducted.

Next, the procedure for attaching the special sheet feed cassette 300 to the cassette 10 will be described.

First, the sheet loading plate 56 (see FIG. 2) in the sheet feed cassette 10 is removed. The sheet loading plate 56 can be easily detached by dissembling the support pins 61 and 62 (see FIG. 2) disposed on the casing inner wall of the cassette 10. In the case that the support pins 61 and 62 have been molded integrally with the casing of the cassette 10, the pins may be detached by allowing the whole plastic product to elastically deform.

Then, a restriction plate for the rear end of sheets 53 (see FIG. 2) as well as side restriction plates 51 and 52 (see FIG. 2) are retracted up to the position where the special sheet feed cassette 300 is insertable. Otherwise, the rear end restriction plate 53 and the side restriction plates 51 and 52 are disassembled.

Thereafter, the special sheet feed cassette 300 is located at a predetermined position of the cassette 10 while maintaining a condition wherein the cover 322 is closed as shown in FIG. 8. Finally, a connector wire for transmitting electrical signals and controlling the special sheet feed cassette 300 is connected to a connecting cable (not shown) in the cassette storage section.

The connecting cable is a flexible cable so that the electrical connection is always assured within a range wherein the cassette 10 is taken in and out. Otherwise, such constitution that electrical connection is implemented in drawer connector connection at the time when the cassette 10 is fitted may be made.

When the cassette 10 to which the special sheet feed cassette 300 has been fitted as described above is attached to the printer main body 900, a lifter plate 57 acts on the sheet loading plate 56A as in the case where a normal cassette 10 is attached. As a consequence, the sheet loading plate 56A is rotated upwards on supporting sections 326 and 327 as the fulcrum; and thereafter a sheet upper surface position is kept substantially constant on the basis of the signals from the sheet surface height sensor 55.

In this case, since the escape hatch 325 for the lifter plate 57 is defined on the bottom of the sheet storage section 320 in the special sheet feed cassette 300 as shown in FIG. 10A, the control of a lifter mechanism can be made as in the case of a usual cassette.

As mentioned above, dehumidification/drying can be implemented by means of the sheet storage section 320 substantially hermetically-closed and the dehumidifier member 354 regenerating the interior of the dehumidifier duct in case of attaching the special sheet feed cassette 300. Moreover, the dehumidifier member 354 which has absorbed moisture can be subjected to heating regeneration by the heater 309 in the heating regeneration duct 352. As a consequence, dehumidification and regeneration of the dehumidifier member 354 can be efficiently implemented. As a result, malfunctions in sheet feeding and the appearance of poor image can be suppressed, and in addition, it can contribute to decrease the electricity consumption of the apparatus.

In the present example, although the dehumidifier device 350 has been disposed on the depth side of the sheet storage section 320 in the special sheet feed cassette 300, the position is not limited to the depth side, but any position may be applied so far as it is the side adjacent to the sheet storage section 320.

Furthermore, although the dehumidifier member 354 has a cylindrical shape in the above description, the present invention is not limited thereto, but any shape can be applied to the dehumidifier member so far as it can partition the dehumidifier duct 351 from the heating regeneration duct 352 in a hermetically-closed condition. In addition, the dehumidifier member 354 may be manually rotated.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2007-097887, filed Apr. 3, 2007, which is hereby incorporated by reference herein in its entirety.

What is claimed is:

1. An image forming apparatus having an image forming section, a sheet storage space, and a dehumidifier device which dehumidifies the sheet storage space, wherein the dehumidifier device comprising:
a dehumidifier member of a heating regeneration type,
a dry space which is dehumidified by the dehumidifier member,
a regeneration space which regenerates the dehumidifier member,
a heating section which is provided in the regeneration space and heats to regenerate the dehumidifier member,
a driving section which transfers the dehumidifier member in a route between the dry space and the regeneration space, and
a partition member which divides the dehumidifier member into a plurality of parts and enables to partition the dry space and the regeneration space.

2. The apparatus according to claim 1, further comprising a stationary wall which partitions the dry space and the regeneration space together with the partition member,
wherein the dehumidifier member is transferred so as to allow the partition member coincides with the stationary wall.

3. The apparatus according to claim 1, further comprising:
a sheet storage section which is attached to the sheet storage space in a manner enabling to take in and out, and stores sheets; and
an attachment detecting section which detects attachment/detachment of the sheet storage section,
wherein the transfer of the dehumidifier member and the heating operation of the heating section is controlled based on the detection results of the attachment detecting section.

4. The apparatus according to claim 1, further comprising:
a sheet storage section which is attached to the sheet storage space and stores sheets; and
a sheet presence/absence detecting section which detects the presence/absence of the sheets in the sheet storage section,
wherein the transfer of the dehumidifier member and the heating operation of the heating section is controlled based on the detection results of the sheet presence/absence detecting section.

5. The apparatus according to claim 1, further comprising a humidity detecting section which detects the humidity of the sheet storage section,
wherein the transfer of the dehumidifier member and the heating operation of the heating section is controlled based on the detection results of the humidity detecting section.

6. The apparatus according to claim 1, further comprising a sheet storage section which stores sheets,
wherein the sheet storage section is hermetically-closed with a cover to form the sheet storage space and the sheet storage space is dehumidified by the dehumidifier device.

7. The apparatus according to claim 1, wherein;
the dehumidifier member is made of a cylinder-shaped porous material which absorbs moisture under an air environment containing moisture, and releases the moisture under a high-temperature environment.
